(19) United States
(12) Patent Application Publication
(10) Pub. No.: US 2026/0321902 A1
(43) Pub. Date: Oct. 15, 2026

(54) ENERGY STORAGE APPARATUS

(71) Applicant: GS Yuasa International Ltd., Kyoto-shi (JP)

(72) Inventors: Ryoichi OKUYAMA, Kyoto-shi (JP); Kazuya OKABE, Kyoto-shi (JP)

(21) Appl. No.: 19/682,688

(22) Filed: May 20, 2026

Related U.S. Application Data
(63) Continuation of application No. PCT/JP2024/039926, filed on Nov. 11, 2024.

(30) Foreign Application Priority Data
Nov. 21, 2023 (JP) 2023-197109

(51) Int. Cl. H01M 50/509; H01M 50/503; H01M 50/547

(52) U.S. Cl. CPC H01M 50/509; H01M 50/503; H01M 50/547

(57) ABSTRACT

In an energy storage apparatus including energy storage devices, an Nth energy storage device at an Nth position from a first energy storage device at an end in a first direction, includes, as an end portion in the first direction, a (2N−1)th end portion where (2N−1)th positive and negative electrode terminals are located, and a (2N)th end portion where (2N)th positive and negative electrode terminals are located. An (N+1)th energy storage device adjacent to the Nth energy storage device includes, as an end portion in the first direction, a (2N+1)th end portion where (2N+1)th positive and negative electrode terminals are located, and a (2N+2)th end portion where (2N+2)th positive and negative electrode terminals are located. The (2N)th and (2N+1)th end portions face each other in the first direction, the (2N)th and (2N+1)th positive electrode terminals are electrically connected, and the (2N)th and (2N+1)th negative electrode terminals are electrically connected.

### CROSS REFERENCE TO RELATED APPLICATIONS

This application claims the benefit of priority to Japanese Patent Application No. 2023-197109 filed on Nov. 21, 2023 and is a Continuation Application of PCT Application No. PCT/JP2024/039926 filed on Nov. 11, 2024. The entire contents of each application are hereby incorporated herein by reference.

### BACKGROUND OF THE INVENTION

### 1. Field of the Invention

The present invention relates to energy storage apparatuses.

### 2. Description of the Related Art

In the related art, methods have been proposed to improve the energy density of a battery pack by housing a large number of long batteries within the battery pack and minimizing an excess space inside the battery pack (see, for example, JP-B2-7197689). Furthermore, a method has been proposed to construct a long battery by housing a plurality of series-connected electrode assembly sets within a case of the long battery. Furthermore, battery packs including a large number of these long batteries connected together have also been proposed (see, for example, JP-B2-7338055).

### SUMMARY OF THE INVENTION

To improve the energy density of batteries, it is necessary to lengthen battery cells or battery modules including the battery cells. However, when the length of the battery cell alone is lengthened, it is more difficult to manufacture the battery cell as the length is longer.

Therefore, example embodiments of the present invention provide energy storage apparatuses that each easily lengthen a battery module.

An energy storage apparatus according to an example embodiment of the present invention includes an energy storage device group in which X energy storage devices arranged in a first direction are electrically connected in parallel. Among the X energy storage devices, an Nth energy storage device, which is an energy storage device located at an Nth position, where N is a natural number and 1≤N≤X−1, from a first energy storage device, which is an energy storage device located at an end in the first direction, includes, as an end portion in the first direction, a (2N−1)th end portion where a (2N−1)th positive electrode terminal and a (2N−1)th negative electrode terminal are located, and a (2N)th end portion where a (2N)th positive electrode terminal and a (2N)th negative electrode terminal are located. An (N+1)th energy storage device adjacent to the Nth energy storage device includes, as an end portion in the first direction, a (2N+1)th end portion where a (2N+1)th positive electrode terminal and a (2N+1)th negative electrode terminal are located, and a (2N+2)th end portion where a (2N+2)th positive electrode terminal and a (2N+2)th negative electrode terminal are located. The (2N)th end portion and the (2N+1)th end portion face each other in the first direction, the (2N)th positive electrode terminal and the (2N+1)th positive electrode terminal are electrically connected, and the (2N)th negative electrode terminal and the (2N+1)th negative electrode terminal are electrically connected.

According to example embodiments of the present invention, it is possible to provide energy storage apparatuses that each easily lengthen an energy storage device group.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating an external appearance of an energy storage apparatus according to an example embodiment of the present invention.

FIG. 2 is an exploded perspective view illustrating individual components when an energy storage apparatus according to an example embodiment of the present invention is disassembled.

FIG. 3 is a perspective view illustrating an external appearance of an energy storage device according to an example embodiment of the present invention.

FIG. 4 is an exploded perspective view illustrating individual components of an energy storage device according to an example embodiment of the present invention when it is disassembled.

FIG. 5 is a perspective view illustrating a configuration of an electrode assembly according to an example embodiment of the present invention.

FIG. 6 is a plan view illustrating an energy storage device group according to an example embodiment of the present invention.

FIG. 7 is a perspective view illustrating a plurality of energy storage device groups according to an example embodiment of the present invention in an unfolded state.

FIG. 8 is a perspective view illustrating a plurality of energy storage device groups according to Modification Example 1 in an unfolded state.

FIG. 9 is a perspective view illustrating a plurality of energy storage device groups according to Modification Example 2 in an unfolded state.

FIG. 10 is a perspective view illustrating a plurality of energy storage device groups according to Modification Example 3 in an unfolded state.

FIG. 11 is an exploded perspective view illustrating individual components of an energy storage device according to Modification Example 4 when it is disassembled.

FIG. 12 is a plan view illustrating an energy storage device group according to Modification Example 5.

FIG. 13A is a top view illustrating a bus bar within an energy storage device group according to Modification Example 6.

FIG. 13B is a perspective view illustrating a bus bar between energy storage device groups according to Modification Example 6.

### DETAILED DESCRIPTION OF THE EXAMPLE EMBODIMENTS

(1) An energy storage apparatus according to an example embodiment of the present invention includes an energy storage device group in which X energy storage devices arranged in a first direction are electrically connected in parallel. Among the X energy storage devices, an Nth energy storage device, which is an energy storage device located at an Nth position, where N is a natural number and 1≤N≤X−1, from a first energy storage device, which is an energy storage device located at an end in the first direction, includes, as an end portion in the first direction, a (2N−1)th end portion where a (2N−1)th positive electrode terminal and a (2N−1)th negative electrode terminal are located, and a (2N)th end portion where a (2N)th positive electrode terminal and a (2N)th negative electrode terminal are located. An (N+1)th energy storage device adjacent to the Nth energy storage device includes, as an end portion in the first direction, a (2N+1)th end portion where a (2N+1)th positive electrode terminal and a (2N+1)th negative electrode terminal are located, and a (2N+2)th end portion where a (2N+2)th positive electrode terminal and a (2N+2)th negative electrode terminal are located. The (2N)th end portion and the (2N+1)th end portion face each other in the first direction, the (2N)th positive electrode terminal and the (2N+1)th positive electrode terminal are electrically connected, and the (2N)th negative electrode terminal and the (2N+1)th negative electrode terminal are electrically connected.

According to the energy storage apparatus described in (1) above, for example, when X is 2 and N is 1, in a first energy storage device and a second energy storage device adjacent in the first direction, a second end portion and a third end portion face each other in the first direction, a second positive electrode terminal and a third positive electrode terminal are electrically connected, and a second negative electrode terminal and a third negative electrode terminal are electrically connected. In other words, the first energy storage device and the second energy storage device, which are located in the first direction, can be electrically connected in parallel to make it possible to form the energy storage device group as a whole in a long shape in the first direction. Accordingly, compared to a case of forming a single energy storage device in a long shape in the first direction, it is possible to easily manufacture an energy storage device group that is elongated in the first direction. Furthermore, when connecting adjacent energy storage devices in parallel, the length of the bus bar joining their terminals can be shortened.

(2) The energy storage apparatus described in (1) above may further include x energy storage device groups, in which the x energy storage device groups may be arranged along a third direction orthogonal to both a second direction, which is a direction in which the (2N)th positive electrode terminal and the (2N)th negative electrode terminal are aligned, and the first direction, and among the x energy storage device groups, an nth energy storage device group, which is an energy storage device group located at an nth position, where n is a natural number and 1≤n≤x−1, from a first energy storage device group, which is an energy storage device group located at an end in the third direction, and an (n+1)th energy storage device group adjacent to the nth energy storage device group may be electrically connected in series.

According to the energy storage apparatus described in (2) above, the nth energy storage device group and the (n+1)th energy storage device group are electrically connected in series while arranged along the third direction to make it possible to make the energy storage apparatus compact. Furthermore, when connecting adjacent energy storage device groups in series, the length of the bus bar joining their terminals can be shortened. (3) In the energy storage apparatus described in (2) above, an arrangement of a first positive electrode terminal and a first negative electrode terminal of a first energy storage device provided in the nth energy storage device group may be an arrangement obtained by inverting, in the second direction, an arrangement of a first positive electrode terminal and a first negative electrode terminal of a first energy storage device provided in the (n+1)th energy storage device group, and an arrangement of a (2X)th positive electrode terminal and a (2X)th negative electrode terminal of an Xth energy storage device provided in the nth energy storage device group may be an arrangement obtained by inverting, in the second direction, an arrangement of a (2X)th positive electrode terminal and a (2X)th negative electrode terminal of an Xth energy storage device provided in the (n+1)th energy storage device group.

According to the energy storage apparatus described in (3) above, for example, when X is 2 and n is 1, the arrangement of the first positive electrode terminal and the first negative electrode terminal of the first energy storage device provided in the first energy storage device group is the arrangement obtained by inverting, in the second direction, the arrangement of the first positive electrode terminal and the first negative electrode terminal of the first energy storage device provided in the second energy storage device group. Similarly, the arrangement of the fourth positive electrode terminal and the fourth negative electrode terminal of the second energy storage device provided in the first energy storage device group is the arrangement obtained by inverting, in the second direction, the arrangement of the fourth positive electrode terminal and the fourth negative electrode terminal of the second energy storage device provided in the second energy storage device group. In other words, the first energy storage device group and the second energy storage device group can have the same type. Therefore, the first energy storage device group and the second energy storage device group can be structurally made common.

(4) The energy storage apparatus described in (2) or (3) above may further include a positive electrode external terminal, a negative electrode external terminal, and a housing that houses the x energy storage device groups, in which the positive electrode external terminal and the negative electrode external terminal may be electrically connected to the x energy storage device groups connected in series.

According to the energy storage apparatus described in (4) above, since the positive electrode external terminal and the negative electrode external terminal of the housing are electrically connected to x energy storage device groups, even when x energy storage device groups are housed in the housing, electrical connection to external devices can be easily made via the positive electrode external terminal and the negative electrode external terminal.

(5) In the energy storage apparatus described in any one of (1) to (4) above, the (2N−1)th end portion may include a (2N−1)th positive electrode notch portion where the (2N−1)th positive electrode terminal is located, and a (2N−1)th negative electrode notch portion where the (2N−1)th negative electrode terminal is located, and the (2N)th end portion may include a (2N)th positive electrode notch portion where the (2N)th positive electrode terminal is located, and a (2N)th negative electrode notch portion where the (2N)th negative electrode terminal is located.

According to the energy storage apparatus described in (5) above, for example, when N is 1, the first positive electrode terminal is located in a first positive electrode notch portion, the first negative electrode terminal is located in a first negative electrode notch portion, the second positive electrode terminal is located in a second positive electrode notch portion, and the second negative electrode terminal is located in a second negative electrode notch portion. Therefore, at least a portion of a conductor (bus bar or the like) connected to each terminal can be disposed within the notch portion. Accordingly, the conductor is less likely to protrude outward from the energy storage device and thus the space consumed outside the energy storage device can be reduced or minimized.

Hereinafter, with reference to the drawings, energy storage apparatuses and energy storage devices according to example embodiments of the present invention (including its modification examples) will be described. Note that the example embodiments described below are all comprehensive or specific examples. The numerical values, shapes, materials, components, the arrangement positions and connection modes of the components, manufacturing processes, and the order of the manufacturing processes shown in the following example embodiments are merely examples and are not intended to limit the present invention. In each drawing, the dimensions and the like are not illustrated strictly. In each drawing, the same or similar components are designated by the same reference numerals. The names of each element (each component) in the present example embodiment are those specific to the present example embodiment and may differ from the names of each element (each component) in the background art.

In the following description and drawings, a direction in which a plurality of energy storage devices are aligned within a single energy storage device group, a direction in which a tab portion protrudes, and a direction along a winding axis of an electrode assembly provided on an energy storage device are defined as an X-axis direction. A direction in which a plurality of energy storage device groups are aligned, a direction in which plates are stacked on a flat portion of the electrode assembly, and a thickness direction of a case of the energy storage device are defined as a Y-axis direction. A direction in which a case lid and a case body of an energy storage apparatus are aligned, or a vertical direction, and a direction in which a pair of curved portions of the electrode assembly face each other are defined as a Z-axis direction. The X-axis direction is an example of a first direction, the Y-axis direction is an example of a third direction, and the Z-axis direction is an example of a second direction. The X-axis direction, the Y-axis direction, and the Z-axis direction are directions intersecting (orthogonal in the present example embodiment) with each other. Depending on the mode of use, the Z-axis direction may not be the vertical direction, but for the sake of convenience, the following description will be given assuming that the Z-axis direction is the vertical direction.

In the following description, for example, a positive X-axis direction refers to an arrow direction of the X axis, and a negative X-axis direction refers to the direction opposite to the positive X-axis direction. The same applies to the Y-axis direction and the Z-axis direction. Furthermore, expressions indicating a relative direction or posture, such as parallel and orthogonal, may include cases where the direction or posture is not strictly the same. For example, two directions being orthogonal not only means that the two directions are completely orthogonal, but also means that the two directions are substantially orthogonal, that is, the two directions may have a difference of, for example, a few percent.

In the following description, the expression “insulation” means “electrical insulation”. The insulating material is preferably made of a material having a volume resistivity of about 1×10¹⁰ Ωm or more, for example.

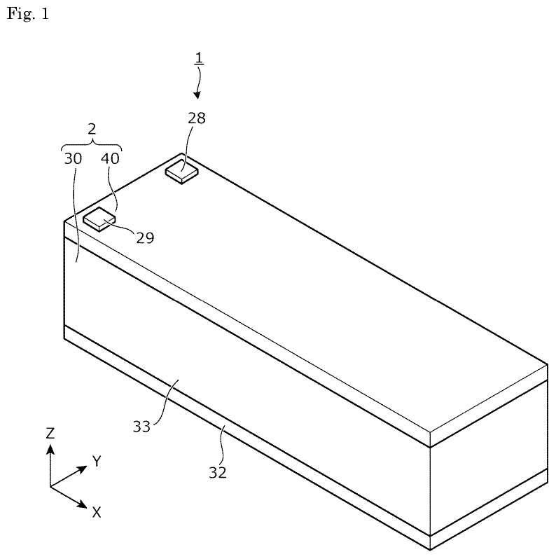

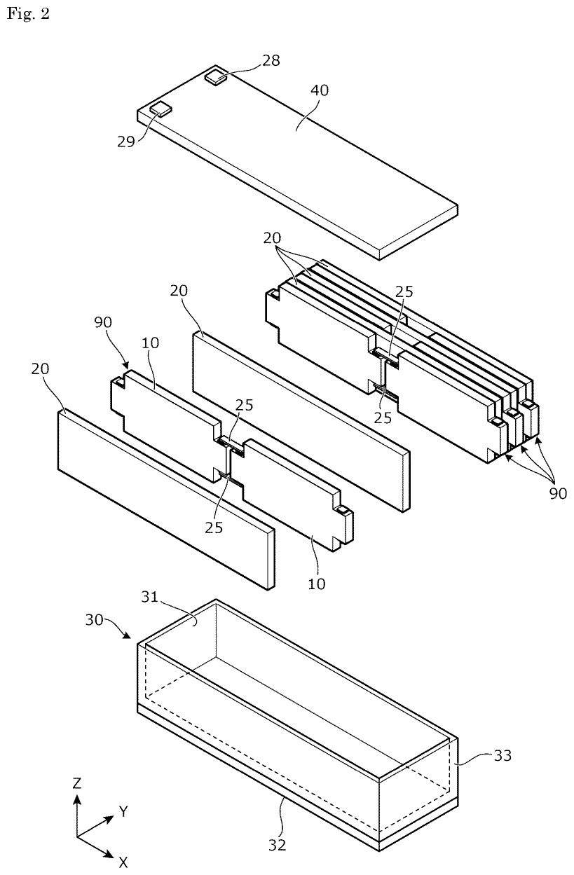

First, a schematic configuration of an energy storage apparatus 1 in the present example embodiment will be described. FIG. 1 is a perspective view illustrating an external appearance of the energy storage apparatus 1 according to the present example embodiment. FIG. 2 is an exploded perspective view illustrating individual components when the energy storage apparatus 1 according to the present example embodiment is disassembled. The energy storage apparatus according to the present example embodiment is illustrated with an example where X is 2 and x is 4, but is not limited thereto.

The energy storage apparatus 1 is an apparatus that can charge electricity from an external source or discharge electricity to an external source, and in the present example embodiment, it has a substantially rectangular parallelepiped shape. The rectangular parallelepiped referred to herein is a hexahedron whose surfaces are all rectangles or squares. The energy storage apparatus 1 is a battery module (assembled battery) used for power storage or power supply purposes. Specifically, the energy storage apparatus 1 is used as a battery for driving or starting the engine of a moving body such as an automobile, a motorcycle, a watercraft, a ship, a snowmobile, an agricultural machine, a construction machine, an automatic guided vehicle (AGV), or a railway vehicle for an electric railway. Examples of the above-mentioned automobiles include electric vehicles (EVs), hybrid electric vehicles (HEVs), plug-in hybrid electric vehicles (PHEVs), and fossil fuel (gasoline, diesel, liquefied natural gas, etc.) automobiles. Examples of the above-mentioned railway vehicles for an electric railway include electric trains, monorails, linear motor cars, and hybrid electric trains equipped with both a diesel engine and an electric motor. The energy storage apparatus 1 can also be used as a stationary battery for home use or business use.

As illustrated in FIG. 1, the energy storage apparatus 1 includes a case 2. As illustrated in FIG. 2, a plurality of energy storage device groups 90, a plurality of spacers 20, a plurality of bus bars 25, and the like are housed in the inside of the case 2. The energy storage apparatus 1 also includes external terminals (a positive electrode external terminal 28 and a negative electrode external terminal 29) for electrically connecting to external devices. In addition to the above-mentioned components, the energy storage apparatus 1 may also include restraining members (end plates, side plates, etc.) that restrain a plurality of energy storage devices 10, a bus bar holder that holds the bus bar 25, a bus bar cover, a circuit board that monitors or controls the charging and discharging states of the energy storage devices 10, electrical components such as relays, fuses, shunt resistors, and connectors, exhaust members that constitute an exhaust path for gases discharged from each energy storage device 10, and the like.

The case 2 is a case (module case) having a substantially rectangular parallelepiped shape (box shape) that constitutes an outer case (housing, outer shell) of the energy storage apparatus 1. The case 2 is located outward of the plurality of energy storage devices 10 and the plurality of spacers 20, etc., and fixes the plurality of energy storage devices 10 and the plurality of spacers 20, etc. in predetermined positions, protecting them from impacts and the like. The case 2 is a metal case formed from metal members such as aluminum, an aluminum alloy, stainless steel, iron, and a plated steel sheet. The case 2 may be formed of an insulating member such as any resin material that can be used for the spacer 20 described later. When the case 2 is formed of a conductive material, the inner surface of the case 2 may be covered with an insulating material to ensure insulation from the energy storage device.

As illustrated in FIG. 2, the case 2 has a case body 30 that constitutes the main body of the case 2 and a case lid 40 that constitutes the lid of the case 2. The case body 30 is a bottomed rectangular cylindrical housing (enclosure) with an opening 31 formed in a positive Z-axis direction, and houses a plurality of energy storage devices 10 and a plurality of spacers 20, etc.

Specifically, the case body 30 has a bottom wall 32 and a side wall 33. The bottom wall 32 is a flat, rectangular portion located at the end portion of the case body 30 in a negative Z-axis direction. The side wall 33 is a rectangular annular wall extending in the positive Z-axis direction from the outer peripheral edge, and is continuously provided around the entire circumference of the bottom wall 32. The inner side of the side wall 33 is the opening 31. The case body 30 may be provided with an exhaust port (not illustrated) for exhausting gas discharged from each energy storage device 10 to the outside of the case 2.

The case lid 40 is a flat, rectangular member that closes the rectangular opening 31 of the case body 30. The case body 30 and the case lid 40 are sealed by joining them together by welding, fusion welding, screwing, or the like. The case body 30 and the case lid 40 may be formed from the same material or from different materials.

As illustrated in FIG. 2, the positive electrode external terminal 28 is located around a corner portion on the upper surface of the case lid 40 in the negative X-axis direction and the positive Y-axis direction. The negative electrode external terminal 29 is located around a corner portion on the upper surface of the case lid 40 in the negative X-axis direction and a negative Y-axis direction. In the present example embodiment, the case in which one positive electrode external terminal 28 and one negative electrode external terminal 29 are provided in the case 2 was illustrated, but a plurality of positive electrode external terminals 28 and a plurality of negative electrode external terminals 29 may be provided in the case 2. The positions of the positive electrode external terminal 28 and the negative electrode external terminal 29 relative to the case body 30 vary depending on the shape, the joining method, and the like of the energy storage device 10, and are not limited to the positional relationship illustrated in FIG. 2.

The energy storage device 10 is a secondary battery (battery cell) that can charge and discharge electricity, and more specifically, a nonaqueous electrolyte secondary battery such as a lithium ion secondary battery. The energy storage device 10 has a shape in which the length in the X-axis direction is longer than the length in the Y-axis direction, specifically, a rectangular parallelepiped shape (prismatic shape) that is flattened in the Y-axis direction. In the present example embodiment, four energy storage device groups 90, each including a plurality of energy storage devices 10, are located side by side in the Y-axis direction. One energy storage device group 90 has two energy storage devices 10 that are aligned in the X-axis direction. Each energy storage device 10 may be covered with an insulating film. A detailed description of the configuration of the energy storage device 10 will be given later.

The spacers 20 are flattened members in the Y-axis direction, arranged side by side with the energy storage device group 90 in the Y-axis direction, and insulating and/or heat-insulating the energy storage device group 90 from other members. The spacer 20 is an insulating plate or a heat insulating plate that is located adjacent to the energy storage device group 90 in the positive Y-axis direction or the negative Y-axis direction of the energy storage device group 90, and insulates and/or heat-insulates the energy storage device groups 90 from each other or the energy storage device group 90 from the case 2. The spacer 20 is formed from an insulating member such as polycarbonate (PC), polypropylene (PP), polyethylene (PE), polystyrene (PS), an ABS resin, or a composite material thereof, or from a heat insulating member such as mica.

Among the spacers 20, the spacers 20 arranged between adjacent energy storage device groups 90 are intermediate spacers, and the two spacers 20 arranged at the end portions of a plurality of energy storage device groups 90 in the Y-axis direction are end spacers. All spacers 20 may be formed of members made of the same material, or any of the spacers 20 may be formed of members made of different materials. The spacer 20 has an external shape based on a flattened rectangular parallelepiped shape. Specifically, the spacer 20 is formed as a rectangle that is elongated in the X-axis direction when viewed in the Y-axis direction. In FIG. 2, the length of the spacer 20 in the X-axis direction is illustrated to be approximately the same as the length of the two energy storage devices 10 aligned in the X-axis direction. However, the length of the spacer 20 may be approximately the same as the length of one energy storage device 10 in the X-axis direction, or it may be shorter than the length of one energy storage device 10 in the X-axis direction. Furthermore, the spacer 20 can be omitted from the viewpoint of improving the energy density of the energy storage apparatus 1.

The bus bar 25 is connected (joined) to terminals 300 of the plurality of energy storage devices 10. Specifically, the plurality of bus bars 25 connect the terminals 300 of the plurality of energy storage devices 10 to each other, and electrically connect the terminals 300 of the energy storage devices 10 to the positive electrode external terminal 28 and the negative electrode external terminal 29. The bus bar 25 and the terminal 300 are connected (joined) by welding or the like, but the form of connection is not particularly limited. The bus bar 25 is formed from a conductor made of metal such as aluminum, an aluminum alloy, copper, a copper alloy, or nickel, or a combination thereof, or from a conductor other than metal.

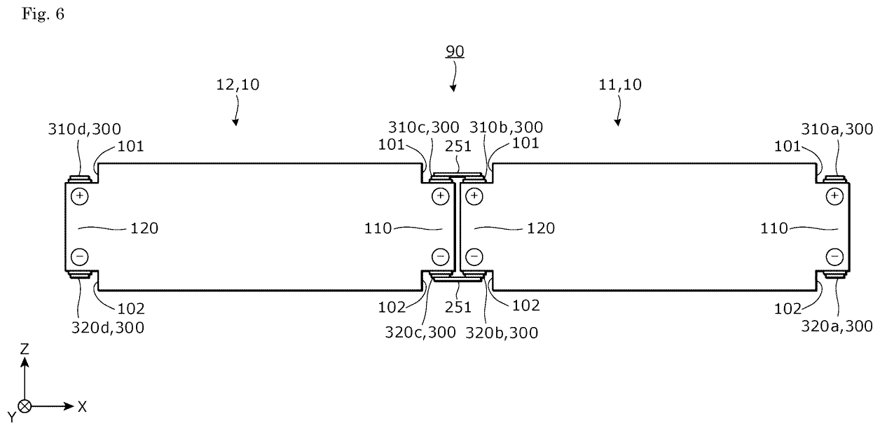

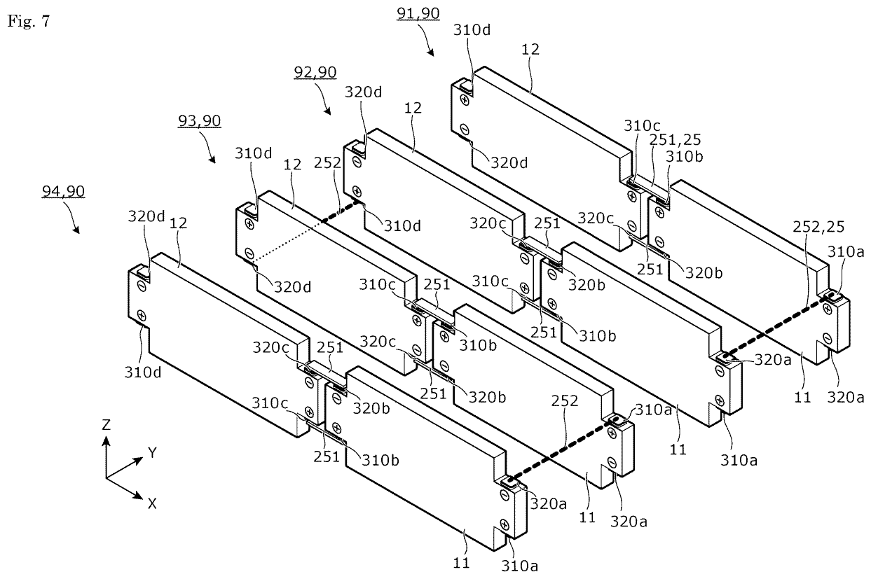

The plurality of bus bars 25 include a parallel bus bar 251 (see FIG. 6), a series bus bar 252 (see FIG. 7), and an external terminal bus bar (not illustrated). The parallel bus bar 251 is a conductor for electrically connecting two adjacent energy storage devices 10 in parallel in the X-axis direction. The series bus bar 252 is a conductor for electrically connecting two adjacent energy storage device groups 90 in series in the Y-axis direction. The external terminal bus bar is a conductor for electrically connecting the plurality of energy storage device groups 90 with the positive electrode external terminal 28 and the negative electrode external terminal 29 in series.

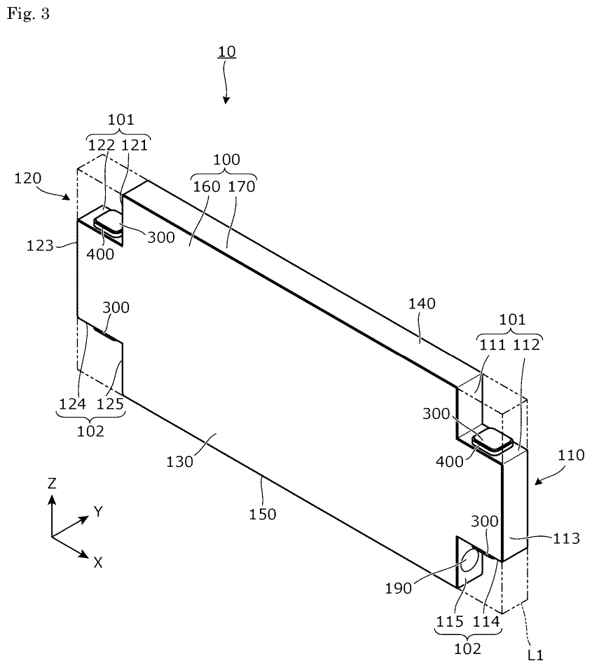

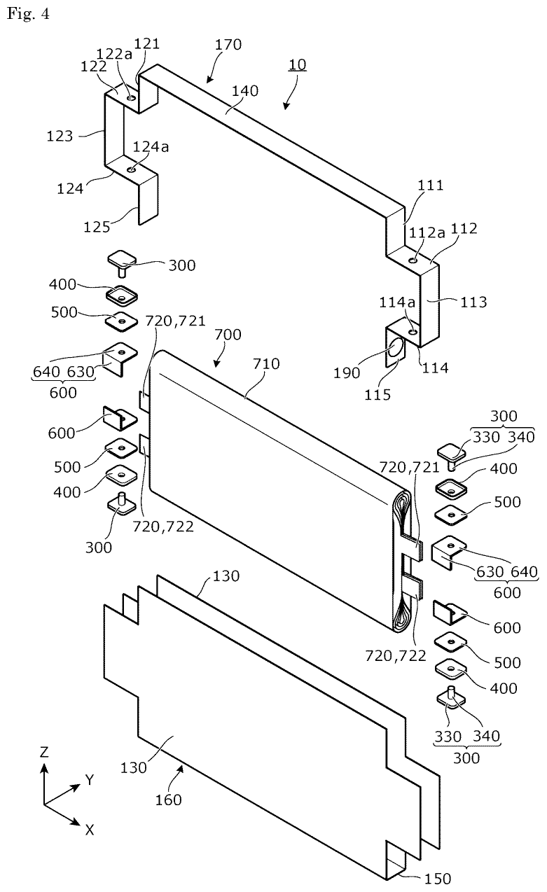

The energy storage device 10 in the example embodiment will be generally described with reference to FIGS. 3 and 4. FIG. 3 is a perspective view illustrating an external appearance of the energy storage device 10 according to the example embodiment. FIG. 4 is an exploded perspective view illustrating individual components of the energy storage device 10 according to the example embodiment when it is disassembled.

The energy storage device 10 is an energy storage device that can charge electricity from an external source or discharge electricity to an external source, and in the present example embodiment, it has a substantially rectangular parallelepiped shape. The energy storage device 10 is not limited to a nonaqueous electrolyte secondary battery; it may be a secondary battery other than a nonaqueous electrolyte secondary battery, or it may be a capacitor. The energy storage device 10 may be a primary battery instead of a secondary battery. Furthermore, the energy storage device 10 may be, for example, an all-solid-state lithium battery using a solid electrolyte, or a polymer lithium battery. Furthermore, the energy storage device 10 may be a pouch-type energy storage device. In the present example embodiment, the energy storage device 10 is illustrated based on a flattened rectangular parallelepiped shape (a substantially rectangular parallelepiped shape). However, the shape of the energy storage device 10, that is, the shape of the case 100, is not limited to a rectangular parallelepiped shape. It may also be based on a polygonal columnar shape other than a rectangular parallelepiped, an elongated cylindrical shape, an elliptical cylindrical shape, or a cylindrical shape, etc.

As illustrated in FIGS. 3 and 4, the energy storage device 10 includes a case 100, four terminals 300, and four external gaskets 400. Four internal gaskets 500, four current collectors 600, and an electrode assembly 700 are housed in the inside of the case 100. The case 100 contains an electrolyte solution (nonaqueous electrolyte), but this is not illustrated in the drawing. There are no particular limitations on the type of electrolyte solution as long as it does not impair the performance of the energy storage device 10, and various types can be selected. In addition to the above components, spacers may be arranged at the side, above, or below the electrode assembly 700, and insulating films may be arranged to enclose the electrode assembly 700, etc.

The case 100 is a case having an outer shape (substantially rectangular parallelepiped shape) based on a rectangular parallelepiped shape that is elongated in the X-axis direction and flattened. The case 100 may have equal lengths in the X-axis direction and the Y-axis direction, or the length in the Y-axis direction may be longer than the length in the X-axis direction. In FIG. 3, the standard rectangular parallelepiped shape is illustrated by a two-dot chain line L1. Specifically, the case 100 has a rectangular parallelepiped shape that is elongated in the X-axis direction and flattened in the Y-axis direction, with an external shape of four rectangular notch portions formed at an upper portion and a lower portion of both end portions in the X-axis direction. Each notch portion can be said to form a recess when viewed from the standard rectangular parallelepiped shape. Among the plurality of notches, a pair of notches located at the upper portion of the case 100 each form a first recess 101, and a pair of notches located at the lower portion of the case 100 each form a second recess 102. In other words, at both end portions of the case 100 in the X-axis direction, the first recess 101 and the second recess 102 are formed at different positions in the Z-axis direction, so that they face each other in the Z-axis direction. Here, the end portion of the case 100 in the positive X-axis direction is defined as a first side surface portion 110, and the end portion thereof in the negative X-axis direction is defined as a second side surface portion 120. The first side surface portion 110 is a portion within 20% of the length of the case 100, in the X-axis direction, from the end surface of the case 100 in the positive X-axis direction. The second side surface portion 120 is a portion within, for example, about 20% of the length of the case 100, in the X-axis direction, from the end surface of the case 100 in the negative X-axis direction.

Specifically, the first side surface portion 110 has a first upper side surface 111, a first upper surface 112, a first middle side surface 113, a first lower surface 114, and a first lower side surface 115, and is elongated in the Z-axis direction when viewed in the X-axis direction. The first upper side surface 111 is located at the upper portion of the first side surface portion 110 and is a rectangular plane that is parallel to the YZ plane and elongated in the Z-axis direction. The first upper surface 112 is a plane that extends in the positive X-axis direction from the lower end of the first upper side surface 111, and is a rectangular plane that is parallel to the XY plane and elongated in the X-axis direction. The first middle side surface 113 is a plane that extends downward from the end portion of the first upper surface 112 in the positive X-axis direction, and is a rectangular plane that is parallel to the YZ plane and elongated in the Z-axis direction. The first lower surface 114 is a plane that extends from the lower end of the first middle side surface 113 in the negative X-axis direction, and is a rectangular plane that is parallel to the XY plane and elongated in the X-axis direction. The first lower side surface 115 is a plane that extends downward from the end portion of the first lower surface 114 in the negative X-axis direction, and is a rectangular plane that is parallel to the YZ plane and elongated in the Z-axis direction.

The first recess 101 of the first side surface portion 110 is formed from the first upper side surface 111 and the first upper surface 112, and is open at the end portion in the positive Z-axis direction and the end portion in the positive X-axis direction. The second recess 102 of the first side surface portion 110 is formed from the first lower surface 114 and the first lower side surface 115, and is open at the end portion in the negative Z-axis direction and the end portion in the positive X-axis direction. Therefore, at the end portion of the first side surface portion 110 in the positive Z-axis direction (the corner portion of the case 100 in both the positive X-axis direction and the positive Z-axis direction), the wall surfaces in the X-axis direction and the Z-axis direction are recessed, and form a shape penetrating in the Y-axis direction. On the other hand, also at the end portion of the first side surface portion 110 in the negative Z-axis direction (the corner portion of the case 100 in the positive X-axis direction and the negative Z-axis direction), the wall surfaces in the X-axis direction and the Z-axis direction are recessed, and form a shape penetrating in the Y-axis direction.

The second side surface portion 120 has a second upper side surface 121, a second upper surface 122, a second middle side surface 123, a second lower surface 124, and a second lower side surface 125, and is elongated in the Z-axis direction when viewed in the X-axis direction. The second upper side surface 121 is located at the upper portion of the second side surface portion 120 and is a rectangular plane that is parallel to the YZ plane and elongated in the Z-axis direction. The second upper surface 122 is a plane that extends from the lower end of the second upper side surface 121 in the negative X-axis direction, and is a rectangular plane that is parallel to the XY plane and elongated in the X-axis direction. The second middle side surface 123 is a plane that extends downward from the end portion of the second upper surface 122 in the negative X-axis direction, and is a rectangular plane that is parallel to the YZ plane and elongated in the Z-axis direction. The second lower surface 124 is a plane that extends from the lower end of the second middle side surface 123 in the positive X-axis direction, and is a rectangular plane that is parallel to the XY plane and elongated in the X-axis direction. The second lower side surface 125 is a plane that extends downward from the end portion of the second lower surface 124 in the positive X-axis direction, and is a rectangular plane that is parallel to the YZ plane and elongated in the Z-axis direction.

The first recess 101 of the second side surface portion 120 is formed from the second upper side surface 121 and the second upper surface 122, and is open at the end portion in the positive Z-axis direction and the end portion in the negative X-axis direction. The second recess 102 of the second side surface portion 120 is formed from the second lower surface 124 and the second lower side surface 125, and is open at the end portion in the negative Z-axis direction and the end portion in the negative X-axis direction. Therefore, at the end portion of the second side surface portion 120 in the positive Z-axis direction (the corner portion of the case 100 in both the negative X-axis direction and the positive Z-axis direction), the wall surfaces in the X-axis direction and the Z-axis direction are recessed, and form a shape penetrating in the Y-axis direction. On the other hand, also at the end portion of the second side surface portion 120 in the negative Z-axis direction (the corner portion of the case 100 in the negative X-axis direction and the negative Z-axis direction), the wall surfaces in the X-axis direction and the Z-axis direction are recessed, and form a shape penetrating in the Y-axis direction.

In this case 100, the two opposing end surfaces in the Y-axis direction are each long side surfaces 130. Each long side surface 130 is a plane parallel to the XZ plane and elongated in the X-axis direction, with both end portions in the X-axis direction having a shape corresponding to the first side surface portion 110 and the second side surface portion 120.

In the case 100, among the two opposing end surfaces in the Z-axis direction, the end surface in the positive Z-axis direction is a top surface 140, and the end surface in the negative Z-axis direction is a bottom surface 150. The top surface 140 is a rectangular plane that is parallel to the XY plane and elongated in the X-axis direction, connecting the upper end of the first upper side surface 111 of the first side surface portion 110 and the upper end of the second upper side surface 121 of the second side surface portion 120. The bottom surface 150 is a rectangular plane that is parallel to the XY plane and elongated in the X-axis direction, connecting the lower end of the first lower side surface 115 of the first side surface portion 110 and the lower end of the second lower side surface 125 of the second side surface portion 120.

The case 100 has a case body 160 and a lid 170, and when the case body 160 and the lid 170 are assembled, it has a substantially rectangular parallelepiped shape. The case body 160 has a pair of long side surfaces 130 and a bottom surface 150. The lid 170 has the first upper side surface 111, the first upper surface 112, the first middle side surface 113, the first lower surface 114, the first lower side surface 115, the second upper side surface 121, the second upper surface 122, the second middle side surface 123, the second lower surface 124, the second lower side surface 125, and the top surface 140.

Specifically, the case body 160 is a plate-shaped metal with a substantially U-shape, open at the top when viewed in the X-axis direction. The case body 160 has a flat plate-shaped long side wall portion of the pair of long side surfaces 130 at both end portions in the Y-axis direction, and a flat, rectangular bottom wall portion of the bottom surface 150 at the end portion in the negative Z-axis direction.

The lid 170 has a shape that is open at the bottom when viewed in the Y-axis direction. The lid 170 has a bent plate portion at the end portion in the positive X-axis direction, which includes the first upper side surface 111, the first upper surface 112, the first middle side surface 113, the first lower surface 114, and the first lower side surface 115; a bent plate portion at the end portion in the negative X-axis direction, which includes the second upper side surface 121, the second upper surface 122, the second middle side surface 123, the second lower surface 124, and the second lower side surface 125; and a flat, rectangular top wall portion at the end portion in the positive Z-axis direction, which includes the top surface 140.

With this configuration, the case 100 is structured such that after the electrode assembly 700 and the like are housed inside the case body 160, the case body 160 and the lid 170 are joined by welding or the like to seal the inside. The material of the case 100 (the case body 160 and the lid 170) is not particularly limited, but it is preferably a weldable metal such as stainless steel, aluminum, an aluminum alloy, iron, and plated steel sheets.

Here, the lid 170 has an electrolyte solution filling portion (not illustrated) and a gas release valve 190 formed therein. The electrolyte solution filling portion is a portion used to fill electrolyte solution into the case 100 during the manufacturing of the energy storage device 10. The gas release valve 190 is a safety valve that releases pressure when the pressure inside the case 100 rises excessively. In the present example embodiment, the gas release valve 190 is provided on the first lower side surface 115.

The terminals 300 are terminals (a positive electrode terminal and a negative electrode terminal) that are electrically connected to the electrode assembly 700 via the current collector 600. In other words, the terminal 300 is a metal member for leading the electricity stored in the electrode assembly 700 to the external space of the energy storage device 10, and also introducing electricity into the internal space of the energy storage device 10 in order to store electricity in the electrode assembly 700. The material of the terminal 300 is not particularly limited, but for example, the terminal 300 is formed of a conductor such as aluminum, an aluminum alloy, copper, or a copper alloy. The terminal 300 is attached to the lid 170 and connected (joined) to the current collector 600 by crimping, welding, or the like.

In the present example embodiment, the terminal 300 has a terminal body portion 330 and a shaft portion 340 that protrudes from the terminal body portion 330. The terminal body portion 330 is a portion that protrudes outward from the terminal installation surface of the case 100. Here, the terminal installation surfaces are the first upper surface 112, the first lower surface 114, the second upper surface 122, and the second lower surface 124. The terminal body portion 330 protrudes outward from the case 100 along the Z-axis direction from one of the terminal installation surfaces. In the lid 170, through holes 112a, 114a, 122a, and 124a are formed at locations corresponding to each terminal installation surface, through which the shaft portion 340 passes. The shaft portion 340 is connected (joined) to the current collector 600 by being crimped through the terminal installation surface of the lid, the external gasket 400, the internal gasket 500, and the current collector 600.

The current collectors 600 are conductive current collecting members that are located in pairs at the end portions in the X-axis direction of the electrode assemblies 700, connected (joined) to the electrode assemblies 700 and the terminals 300, thereby electrically connecting the electrode assemblies 700 and the terminals 300. Specifically, the current collector 600 integrally has a first joint 630 and a second joint 640. The first joint 630 is connected (joined) to a tab portion 720 of the electrode assembly 700, which will be described later, by welding, crimping, or the like. The second joint 640 is connected (joined) to the terminal 300 by crimping, welding, or the like. The first joint 630 and the second joint 640 are both flat plate-shaped portions, formed by bending a single plate-like metal. The material of the current collector 600 is not particularly limited, but it is formed of a conductor such as aluminum, an aluminum alloy, copper, or a copper alloy.

The external gasket 400 is a plate-shaped insulating sealing member that is located between the lid 170 and the terminal 300 of the case 100, and insulates and seals the space between the lid 170 and the terminal 300. The internal gasket 500 is a plate-shaped insulating sealing member that is located between the lid 170 and the current collector 600, and insulates and seals the space between the lid 170 and the current collector 600. In the present example embodiment, the external gasket 400 and the internal gasket 500 are rectangular in shape. The external gasket 400 and the internal gasket 500 are formed from electrically insulating resins such as polypropylene (PP), polyethylene (PE), polystyrene (PS), an ABS resin, or composite materials thereof.

The electrode assembly 700 is an energy storage element (power generating element) that can store electricity, formed by winding plates. The electrode assembly 700 has an elongated shape extending in the X-axis direction and has an oval shape when viewed from the X-axis direction. In the present example embodiment, the length of the electrode assembly 700 in the X-axis direction is 100 mm or more. The length of the electrode assembly 700 in the X-axis direction may be less than 100 mm, for example, about 30 mm. The electrode assembly 700 may have a length in the X-axis direction that is longer than its length in the Z-axis direction. The electrode assembly 700 has a main body portion 710 and a plurality of tab portions 720 protruding from the main body portion 710, and as described above, the tab portions 720 are connected (joined) to the current collector 600.

Specifically, two of the plurality of tab portions 720 protrude from each of both end surfaces in the X-axis direction of the main body portion 710. One end surface of the main body portion 710 in the positive X-axis direction is provided with a positive electrode tab portion 721 and a negative electrode tab portion 722, while the other end surface of the main body portion 710 in the negative X-axis direction is also provided with a positive electrode tab portion 721 and a negative electrode tab portion 722.

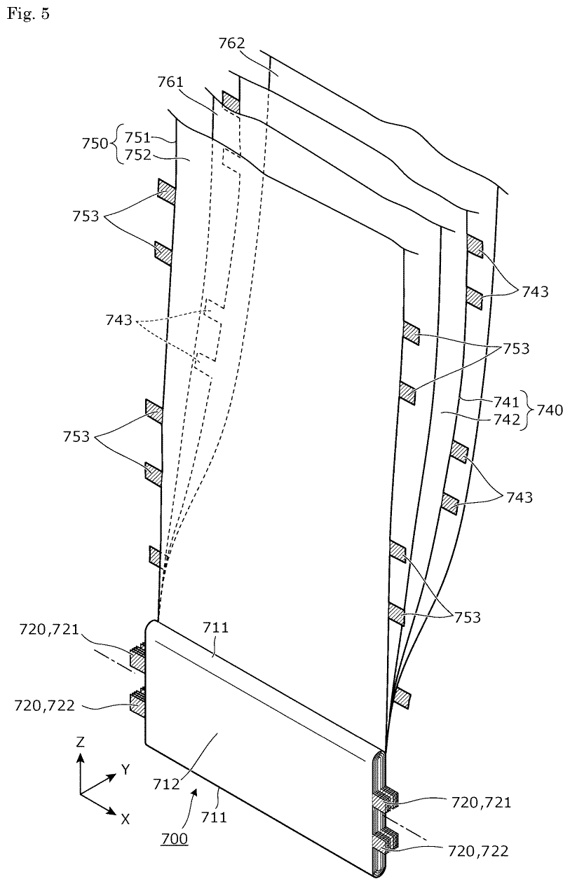

FIG. 5 is a perspective view illustrating a configuration of the electrode assembly 700 according to the present example embodiment. Specifically, FIG. 5 illustrates the configuration of the electrode assembly 700 with the winding state of the plate partially unfolded. As illustrated in FIG. 5, the electrode assembly 700 includes a positive electrode plate 740, a negative electrode plate 750, and separators 761 and 762.

The positive electrode plate 740 is a plate (electrode plate) in which a positive active material layer 742 is formed on the surface of a positive electrode current collector foil 741, which is an elongated, strip-shaped metal foil. Aluminum, an aluminum alloy, or the like is used for the positive electrode current collector foil 741. The negative electrode plate 750 is a plate (electrode plate) in which a negative active material layer 752 is formed on the surface of a negative electrode current collector foil 751, which is an elongated, strip-shaped metal foil. Copper, a copper alloy, or the like is used for the negative electrode current collector foil 751. As the positive active material used in the positive active material layer 742 and the negative active material used in the negative active material layer 752, any known materials can be used as appropriate, as long as they are capable of occluding and releasing lithium ions.

For example, as the positive active material, polyanionic compounds such as LiMPO₄, LiMSiO₄, and LiMBO₃ (where M is one or more transition metal elements selected from Fe, Ni, Mn, Co, etc.), lithium titanate, spinel-type lithium manganese oxides such as LiMn₂O₄ and LiMn_{1.5}Ni_{0.5}O₄, and lithium transition metal oxides such as LiMO₂ (where M is one or more transition metal elements selected from Fe, Ni, Mn, Co, etc.) can be used. Examples of negative active materials include lithium metal, alloys capable of occluding and releasing lithium, carbon materials (for example, graphite, non-graphitizable carbon, easily graphitizable carbon, low-temperature calcined carbon, amorphous carbon, etc.), and silicon oxides.

The separators 761 and 762 are microporous sheets formed from resin. As for the materials of the separators 761 and 762, any known materials can be used as appropriate, as long as they do not impair the performance of the energy storage device 10. For example, as the separators 761 and 762, woven fabrics, nonwoven fabrics, synthetic resin microporous membranes formed from polyolefin resins such as polyethylene, which are insoluble in organic solvents, can be used.

The electrode assembly 700 is formed by winding together the positive electrode plate 740, the negative electrode plate 750, and the separators 761 and 762. Specifically, the electrode assembly 700 is formed by stacking and winding the negative electrode plate 750, the separator 761, the positive electrode plate 740, and the separator 762 in that order. In the present example embodiment, a wound electrode assembly 700 is formed by winding the positive electrode plate 740 and the negative electrode plate 750, etc., around a winding axis L that extends in the X-axis direction. The winding axis L is a virtual axis that serves as the central axis when winding the positive electrode plate 740, the negative electrode plate 750, etc. In the present example embodiment, the winding axis L is a straight line parallel to the X-axis direction passing through the center of the electrode assembly 700.

At both edges of the positive electrode plate 740 in the winding axis direction (X-axis direction), a plurality of protruding pieces 743 are located at intervals, each protruding outward. Similarly, at both edges of the negative electrode plate 750 in the winding axis direction, a plurality of protruding pieces 753 are located at intervals, each protruding outward. Each of the protruding pieces 743 and 753 is a portion where an active material layer containing the active material has not been formed and the metal foil (current collector foil) is exposed (an active material layer non-forming portion). The shaded portion in FIG. 5 corresponds to the active material layer non-forming portion.

When the positive electrode plate 740 and the negative electrode plate 750 are wound with the separators 761 and 762, the protruding pieces 743 of the positive electrode plate 740 overlap and the protruding pieces 753 of the negative electrode plate 750 overlap at each end surface (one end surface and the other end surface) of the main body portion 710. In the present example embodiment, each end surface of the main body portion 710 is a surface of the electrode assembly 700 as viewed from the X-axis direction. The portion where the protruding pieces 743 of the positive electrode plate 740 overlap is the positive electrode tab portion 721. In other words, the positive electrode tab portion 721 is a portion formed by stacking a plurality of pieces (protruding pieces 743) of one plate (the positive electrode plate 740) having the same polarity among the plates (the positive electrode plate 740 and the negative electrode plate 750).

Similarly, the portion where the protruding pieces 753 of the negative electrode plate 750 overlap is the negative electrode tab portion 722. In other words, the negative electrode tab portion 722 is a portion formed by stacking a plurality of pieces (protruding pieces 753) of plates having the same polarity (the negative electrode plate 750) among a plurality of plates (the positive electrode plate 740 and the negative electrode plate 750).

Thus, the electrode assembly 700 has the main body portion 710 that constitutes the main body of the electrode assembly 700, and the plurality of tab portions 720 (the positive electrode tab portion 721 and the negative electrode tab portion 722) that protrude in pairs from each of both end surfaces in the X-axis direction from the main body portion 710. Specifically, at both end surfaces of the main body portion 710, the positive electrode tab portion 721 is located at the upper portion (in the positive Z-axis direction), and the negative electrode tab portion 722 is located at the lower portion (in the negative Z-axis direction).

The main body portion 710 is an elongated cylindrical portion (active material layer forming portion) formed by winding together the portion of the positive electrode plate 740 on which the positive active material layer 742 is formed (coated), the portion of the negative electrode plate 750 on which the negative active material layer 752 is formed (coated), and the separators 761 and 762. The main body portion 710 has a pair of curved portions 711 at each end portion in the Z-axis direction, and a flat portion 712 that is flat overall between this pair of curved portions 711. It can also be said that the pair of curved portions 711 are located at positions sandwiching the flat portion 712 in the Z-axis direction.

The curved portion 711 is a curved portion that is curved in a semicircular arc shape to protrude in the Z-axis direction when viewed from the X-axis direction, and extends in the X-axis direction. The curved portion 711 in the positive Z-axis direction is located opposite the top wall portion of the lid 170, and the curved portion 711 in the negative Z-axis direction is located opposite the bottom wall portion of the case body 160. In other words, among the pair of curved portions 711, the curved portion 711 in the positive Z-axis direction is a portion that, when viewed from the X-axis direction, is curved to protrude from the flat portion 712 toward the top wall portion of the lid 170 in the positive Z-axis direction. Among the pair of curved portions 711, the curved portion 711 in the negative Z-axis direction is a portion that, when viewed from the X-axis direction, is curved to protrude from the flat portion 712 toward the bottom wall portion of the case body 160 in the negative Z-axis direction.

The flat portion 712 is a rectangular and flat portion that connects the end portions of the pair of curved portions 711, extending parallel to the XZ plane oriented in the Y-axis direction, and is located opposite the long side wall portions on both sides of the case body 160 in the Y-axis direction. The flat portion 712 is a main portion of the electrode assembly 700, and in this flat portion 712, a plurality of wound plates (the positive electrode plate 740 and the negative electrode plate 750) are stacked in the Y-axis direction. In other words, in the flat portion 712, the Y-axis direction is the stacking direction of the plurality of plates. As mentioned above, since the flat portion 712 is a main portion of the electrode assembly 700, here, the main stacking direction of the electrode assembly 700 is defined as the Y-axis direction.

The curved shape of the curved portion 711 is not limited to a semicircular arc shape, but may also be a part of an elliptical shape, or may be curved in any manner. The flat portion 712 is not limited to having a flat outer surface facing the Y-axis direction, and the outer surface may be slightly concave or slightly convex.

Next, the energy storage device group 90 will be described. FIG. 6 is a plan view illustrating the energy storage device group 90 according to the present example embodiment. In FIG. 6, for convenience of description, the polarity of each terminal 300 is indicated by a mark (the positive electrode terminal is “+”, and the negative electrode terminal is “−”). Such a mark may or may not be provided on the actual energy storage device 10. The polarity of each terminal 300 on the actual energy storage device 10 may be identified by color.

As illustrated in FIG. 6, the two energy storage devices 10 that constitute the energy storage device group 90 are located side by side in the X-axis direction. Here, the energy storage device 10 in the positive X-axis direction is referred to as a first energy storage device 11, and the energy storage device 10 in the negative X-axis direction is referred to as a second energy storage device 12. Thus, in the present example embodiment, the case in which the above N is added from the first energy storage device 11 to the Xth energy storage device, moving from the positive X-axis direction to the negative X-axis direction, is illustrated. The above N may be added from the first energy storage device 11 to the Xth energy storage device, moving from the negative X-axis direction to the positive X-axis direction.

The first energy storage device 11 includes, as terminals 300, a first positive electrode terminal 310a, a second positive electrode terminal 310b, a first negative electrode terminal 320a, and a second negative electrode terminal 320b. Specifically, the first positive electrode terminal 310a and the first negative electrode terminal 320a are located at the first end portion (the first side surface portion 110) in the positive X-axis direction of the first energy storage device 11. The first positive electrode terminal 310a is located in the first recess 101 of the first side surface portion 110, and the first negative electrode terminal 320a is located in the second recess 102 of the first side surface portion 110. In other words, the first recess 101 of the first side surface portion 110 is an example of a first positive electrode notch portion, and the second recess 102 of the first side surface portion 110 is an example of a first negative electrode notch portion.

The second positive electrode terminal 310b and the second negative electrode terminal 320b are located at the second end portion (the second side surface portion 120) in the negative X-axis direction of the first energy storage device 11. The second positive electrode terminal 310b is located in the first recess 101 of the second side surface portion 120, and the second negative electrode terminal 320b is located in the second recess 102 of the second side surface portion 120. In other words, the first recess 101 of the second side surface portion 120 is an example of a second positive electrode notch portion, and the second recess 102 of the second side surface portion 120 is an example of a second negative electrode notch portion.

The second energy storage device 12 includes, as terminals 300, a third positive electrode terminal 310c, a fourth positive electrode terminal 310d, a third negative electrode terminal 320c, and a fourth negative electrode terminal 320d. Specifically, the third positive electrode terminal 310c and the third negative electrode terminal 320c are located at the third end portion (the first side surface portion 110) in the positive X-axis direction of the second energy storage device 12. The third positive electrode terminal 310c is located in the first recess 101 of the first side surface portion 110, and the third negative electrode terminal 320c is located in the second recess 102 of the first side surface portion 110.

The fourth positive electrode terminal 310d and the fourth negative electrode terminal 320d are located at the fourth end portion (the second side surface portion 120) in the negative X-axis direction of the second energy storage device 12. The fourth positive electrode terminal 310d is located in the first recess 101 of the second side surface portion 120, and the fourth negative electrode terminal 320d is located in the second recess 102 of the second side surface portion 120.

In the energy storage device group 90, the second end portion of the first energy storage device 11 and the third end portion of the second energy storage device 12 face each other in the X-axis direction. The second positive electrode terminal 310b and the third positive electrode terminal 310c are electrically connected by a parallel bus bar 251, and the second negative electrode terminal 320b and the third negative electrode terminal 320c are electrically connected by a parallel bus bar 251. Each parallel bus bar 251 is housed within the first recess 101 or the second recess 102 in the Z-axis direction, and is configured not to protrude beyond the outer shape of the case 100 in the Z-axis direction. Therefore, each parallel bus bar 251 consumes less space outside the case 100. Furthermore, a part of each parallel bus bar 251 may protrude in the Z-axis direction from the first recess 101 or the second recess 102. Even in this case, since the other part of each parallel bus bar 251 is housed in the first recess 101 or the second recess 102 in the Z-axis direction, the space consumed outside the case 100 can be reduced or minimized.

FIG. 7 is a perspective view illustrating a plurality of energy storage device groups 90 according to the example embodiment in an unfolded state. In FIG. 7, the series bus bar 252 is illustrated with a broken line, and the gas release valve 190 is not illustrated. As illustrated in FIG. 7, the plurality of energy storage device groups 90 (four energy storage device groups 90) are located along the Y-axis direction and electrically connected in series. Here, starting from the positive Y-axis direction, the four energy storage device groups are referred to as a first energy storage device group 91, a second energy storage device group 92, a third energy storage device group 93, and a fourth energy storage device group 94. In the present example embodiment, the case in which the above n is added from the first energy storage device group 91 to the xth energy storage device group, moving from the positive Y-axis direction to the negative Y-axis direction, is illustrated. The above n may be added from the first energy storage device group 91 to the xth energy storage device group, moving from the negative Y-axis direction to the positive Y-axis direction. The first energy storage device group 91, the second energy storage device group 92, the third energy storage device group 93, and the fourth energy storage device group 94 are the same type of energy storage device groups. Here, the “same type of energy storage device groups” means that the overall shape of one energy storage device group and another energy storage device group used for comparison are the same or similar. It is not necessary for all portions that constitute the energy storage device group to be similar. The arrangement of terminals (positive electrode terminal, negative electrode terminal) within one energy storage device group only needs to be the same as the arrangement of terminals (positive electrode terminal, negative electrode terminal) within another energy storage device group used for comparison. In this case, if rotating one of a certain energy storage device group and another energy storage device group vertically or horizontally results in the same arrangement of terminals within the one energy storage device group as the arrangement of terminals within the other energy storage device group, then the two groups can be said to be of the same type.

The positive electrode terminals of the first energy storage device group 91 and the positive electrode terminals of the third energy storage device group 93 are located at the upper portion of the case 100, while the positive electrode terminals of the second energy storage device group 92 and the positive electrode terminals of the fourth energy storage device group 94 are located at the lower portion of the case 100. In other words, the arrangement of the positive electrode terminal and the negative electrode terminal provided in the first energy storage device group 91 and the third energy storage device group 93 is the arrangement obtained by inverting, in the Z-axis direction, the arrangement of the positive electrode terminal and the negative electrode terminal provided in the second energy storage device group 92 and the fourth energy storage device group 94. Furthermore, in the present example embodiment in which each energy storage device group has X=2, that is, is including the first energy storage device 11 and the second energy storage device 12, the arrangement of terminals located at the end portions in the X-axis direction is as follows. The arrangement of the first positive electrode terminal 310a and the first negative electrode terminal 320a of the first energy storage device 11 of the first energy storage device group 91 is the arrangement obtained by inverting, in the Z-axis direction, the arrangement of the first positive electrode terminal 310a and the first negative electrode terminal 320a of the first energy storage device 11 of the second energy storage device group 92. Furthermore, the arrangement of the fourth positive electrode terminal 310d and the first negative electrode terminal 320d of the second energy storage device 12 of the first energy storage device group 91 is the arrangement obtained by inverting, in the Z-axis direction, the arrangement of the fourth positive electrode terminal 310d and the fourth negative electrode terminal 320d of the second energy storage device 12 of the second energy storage device group 92.

The first positive electrode terminal 310a of the first energy storage device 11 of the first energy storage device group 91 and the first negative electrode terminal 320a of the first energy storage device 11 of the second energy storage device group 92 are electrically directly connected by a series bus bar 252. The fourth positive electrode terminal 310d of the second energy storage device 12 of the second energy storage device group 92 and the fourth negative electrode terminal 320d of the second energy storage device 12 of the third energy storage device group 93 are electrically directly connected by a series bus bar 252. The first positive electrode terminal 310a of the first energy storage device 11 of the third energy storage device group 93 and the first negative electrode terminal 320a of the first energy storage device 11 of the fourth energy storage device group 94 are electrically directly connected by a series bus bar 252. It is preferable that each series bus bar 252 is housed within the first recess 101 and the second recess 102, similarly to each parallel bus bar 251, and does not protrude from the case 100 in the Z-axis direction.

The fourth positive electrode terminal 310d of the second energy storage device 12 of the first energy storage device group 91 is electrically connected in series with the positive electrode external terminal 28 via an external terminal bus bar (not illustrated) or the like. The fourth negative electrode terminal 320d of the second energy storage device 12 of the first energy storage device group 91 is electrically connected in series with the negative electrode external terminal 29 via an external terminal bus bar or the like (see FIG. 2). The fourth positive electrode terminal 310d of the second energy storage device 12 of the fourth energy storage device group 94 is electrically connected in series with the positive electrode external terminal 28 via an external terminal bus bar or the like. The fourth negative electrode terminal 320d of the second energy storage device 12 of the fourth energy storage device group 94 is electrically connected in series with the negative electrode external terminal 29 via an external terminal bus bar or the like (see FIG. 2). It is preferable that each external terminal bus bar is housed within the first recess 101 and the second recess 102, similarly to each parallel bus bar 251, and does not protrude from the case 100 in the Z-axis direction.

As described above, according to the present example embodiment of the present invention, in the first energy storage device 11 and the second energy storage device 12 that are adjacent in the X-axis direction (first direction), the second positive electrode terminal 310b and the third positive electrode terminal 310c are electrically connected, and the second negative electrode terminal 320b and the third negative electrode terminal 320c are electrically connected. In other words, the first energy storage device 11 and the second energy storage device 12, which are located in the X-axis direction, can be electrically connected in parallel, thereby making it possible to form the energy storage device group 90 as a whole in a long shape in the X-axis direction. Accordingly, compared to a case of forming a single energy storage device 10 in a long shape in the X-axis direction, it is possible to easily manufacture the energy storage device group 90 that is elongated in the X-axis direction.

Therefore, by adjusting the number of energy storage devices 10 that constitute the energy storage device group 90, the length of the energy storage device group 90 in the X-axis direction can be adjusted, providing a high degree of freedom in design.

To describe in more detail, according to the present example embodiment, when connecting four-terminal energy storage devices 10 in parallel in the longitudinal direction, and when connecting an energy storage device group 90 formed by connecting the energy storage devices 10 in parallel in series, it is possible to shorten the bus bars (the series bus bar 252 and the parallel bus bar 251) that join the terminals. This reduces the resistance of the energy storage apparatus 1. Furthermore, it is possible to improve the power and charging performance of the energy storage apparatus 1. In addition, the cost of the energy storage apparatus 1 can also be reduced.

Each energy storage device 10 includes two positive electrode terminals and two negative electrode terminals, and these are electrically connected in parallel, and therefore the electrical resistance after connection can be reduced or minimized.

Since a plurality of energy storage device groups 90 are electrically connected in series while arranged along the Y-axis direction (third direction), it is possible to make the energy storage apparatus 1 compact. Specifically, in adjacent energy storage device groups 90, the terminals connected in series are adjacent in the Y-axis direction (third direction), and therefore the length of the conductor and the space required to route the conductor can be small. As a result, it becomes possible to make the energy storage apparatus 1, which includes a plurality of energy storage device groups 90, more compact.

The arrangement of the positive electrode terminal and the negative electrode terminal provided in the first energy storage device group 91 is the arrangement obtained by inverting, in the Z-axis direction (second direction), the arrangement of the positive electrode terminal and the negative electrode terminal provided in the second energy storage device group 92. Therefore, the first energy storage device group 91 and the second energy storage device group 92 can have the same type. Therefore, the first energy storage device group 91 and the second energy storage device group 92 can be structurally made common. The same applies to the third energy storage device group 93 and the fourth energy storage device group 94.

Thus, the arrangement of the first positive electrode terminal 310a and the first negative electrode terminal 320a of the first energy storage device 11 provided in the first energy storage device group 91 is the arrangement obtained by inverting, in the Z-axis direction, the arrangement of the first positive electrode terminal 310a and the first negative electrode terminal 320a of the first energy storage device 11 provided in the second energy storage device group 92. On the other hand, the arrangement of the fourth positive electrode terminal 310d and the fourth negative electrode terminal 320d of the second energy storage device provided in the first energy storage device group is the arrangement obtained by inverting, in the Z-axis direction, the arrangement of the fourth positive electrode terminal 310d and the fourth negative electrode terminal 320d of the second energy storage device provided in the second energy storage device group. In other words, the arrangement of the terminals (the positive electrode terminal and the negative electrode terminal) at both end portions of a certain energy storage device group 90 (for example, the first energy storage device group 91) is the arrangement obtained by inverting, in the Z-axis direction, the arrangement of the terminals at both end portions of an adjacent energy storage device group 90 (for example, the second energy storage device group 92).

Since the positive electrode external terminal 28 and the negative electrode external terminal 29 of the case 2 (housing) are electrically connected to a plurality of energy storage device groups 90, even when a plurality of energy storage device groups 90 are housed in the case 2, electrical connection to external devices can be easily made via the positive electrode external terminal 28 and the negative electrode external terminal 29.

The first positive electrode terminal 310a is located in the first recess 101 (first positive electrode notch portion) of the first side surface portion 110, and the first negative electrode terminal 320a is located in the second recess 102 (first negative electrode notch portion) of the first side surface portion 110. Similarly, the second positive electrode terminal 310b is located in the first recess 101 (second positive electrode notch portion) of the second side surface portion 120, and the second negative electrode terminal 320b is located in the second recess 102 (second negative electrode notch portion) of the second side surface portion 120. Therefore, at least a part of the conductors (parallel bus bars, series bus bars, and external terminal bus bars) connected to each terminal can be disposed within the first recess 101 and the second recess 102. Accordingly, the conductor is less likely to protrude outward from the energy storage device 10 and thus the space consumed outside the energy storage device 10 can be reduced or minimized.

Various modification examples of the above example embodiments will be described below. In the following description, parts identical to those in the above example embodiments or other modification examples may be denoted by the same reference numerals, and their descriptions may be omitted.

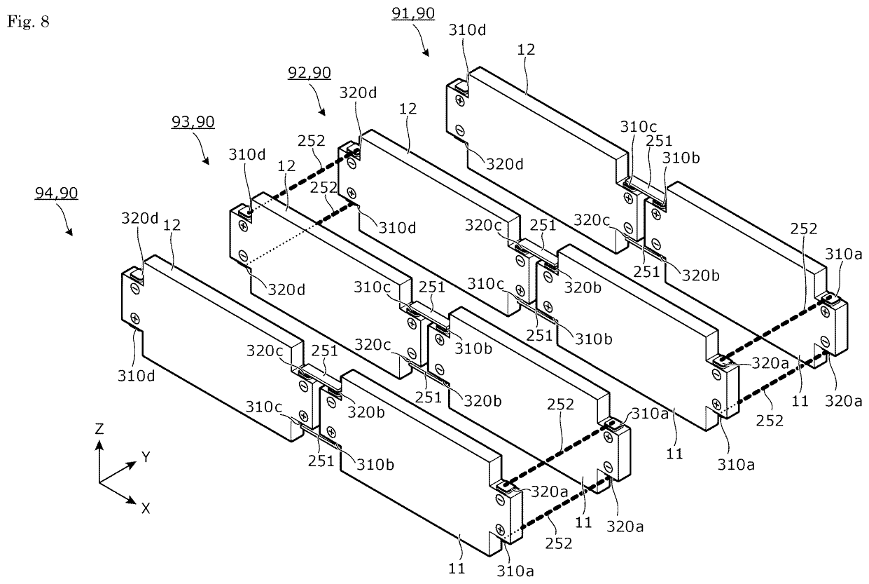

Modification Example 1 of the above example embodiments will be described. In the above example embodiments, an example was given in which two adjacent energy storage device groups 90 in the Y-axis direction are electrically connected in series by only one series bus bar 252. This Modification Example 1 describes the case where two adjacent energy storage device groups 90 in the Y-axis direction are electrically connected in series by two series bus bars 252. FIG. 8 is a perspective view illustrating a plurality of energy storage device groups 90 according to Modification Example 1 in an unfolded state. FIG. 8 is a diagram that corresponds to FIG. 7.

As illustrated in FIG. 8, the first positive electrode terminal 310a of the first energy storage device 11 of the first energy storage device group 91 and the first negative electrode terminal 320a of the first energy storage device 11 of the second energy storage device group 92 are electrically directly connected by a series bus bar 252. The first negative electrode terminal 320a of the first energy storage device 11 of the first energy storage device group 91 and the first positive electrode terminal 310a of the first energy storage device 11 of the second energy storage device group 92 are electrically directly connected by a series bus bar 252. The fourth positive electrode terminal 310d of the second energy storage device 12 of the second energy storage device group 92 and the fourth negative electrode terminal 320d of the second energy storage device 12 of the third energy storage device group 93 are electrically directly connected by a series bus bar 252. The fourth negative electrode terminal 320d of the second energy storage device 12 of the second energy storage device group 92 and the fourth positive electrode terminal 310d of the second energy storage device 12 of the third energy storage device group 93 are electrically directly connected by a series bus bar 252. The first positive electrode terminal 310a of the first energy storage device 11 of the third energy storage device group 93 and the first negative electrode terminal 320a of the first energy storage device 11 of the fourth energy storage device group 94 are electrically directly connected by a series bus bar 252. The first negative electrode terminal 320a of the first energy storage device 11 of the third energy storage device group 93 and the first positive electrode terminal 310a of the first energy storage device 11 of the fourth energy storage device group 94 are electrically directly connected by a series bus bar 252. In other words, a plurality of energy storage device groups 90 (the first energy storage device group 91, the second energy storage device group 92, the third energy storage device group 93, and the fourth energy storage device group 94) are connected in series.

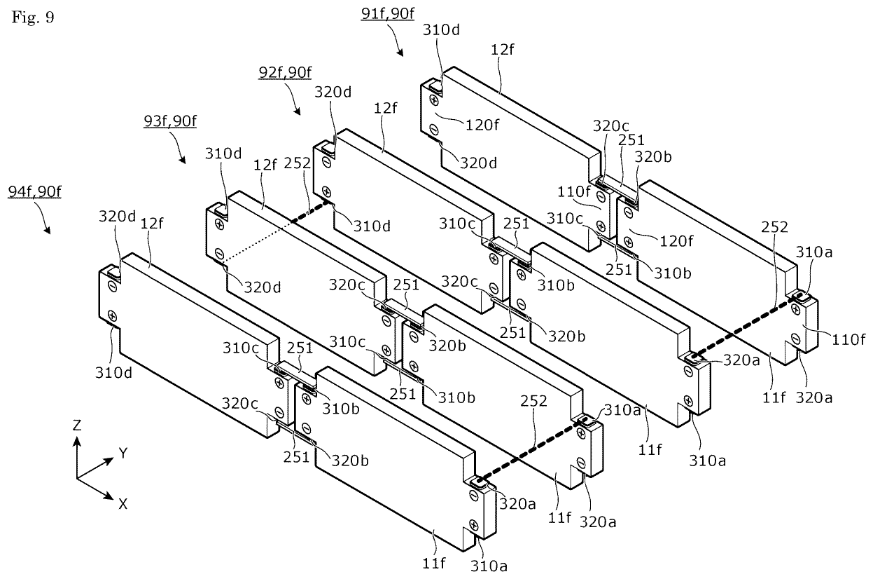

Modification Example 2 of the above example embodiments will be described. In the above example embodiments, an example was given in which the positive electrode terminal and the negative electrode terminal are located similarly on the first side surface portion 110 and the second side surface portion 120 of the energy storage device 10. This Modification Example 2 illustrates a case where the positive electrode terminal and the negative electrode terminal of the energy storage device are located to be inverted in the Z-axis direction on the first side surface portion and the second side surface portion. FIG. 9 is a perspective view illustrating a plurality of energy storage device groups 90f according to Modification Example 2 in an unfolded state. FIG. 9 is a diagram that corresponds to FIG. 7.

As illustrated in FIG. 9, in a first energy storage device 11f of the first energy storage device group 91f, the first positive electrode terminal 310a is located at the upper portion of a first side surface portion 110f, and the first negative electrode terminal 320a is located at the lower portion of the first side surface portion 110f. On the other hand, in the first energy storage device 11f of the first energy storage device group 91f, the second negative electrode terminal 320b is located at the upper portion of a second side surface portion 120f, and the second positive electrode terminal 310b is located at the lower portion of the second side surface portion 120f.

In a second energy storage device 12f of the first energy storage device group 91f, the third negative electrode terminal 320c is located at the upper portion of the first side surface portion 110f, and the third positive electrode terminal 310c is located at the lower portion of the first side surface portion 110f. On the other hand, in the second energy storage device 12f of the first energy storage device group 91f, the fourth positive electrode terminal 310d is located at the upper portion of the second side surface portion 120f, and the fourth negative electrode terminal 320d is located at the lower portion of the second side surface portion 120f. In other words, the first energy storage device 11f and the second energy storage device 12f are the same type of energy storage devices that are inverted in the Y-axis direction. Here, the “same type of energy storage devices” means that the overall shape of one energy storage device and another energy storage device used for comparison are the same or similar. It is not necessary for all portions that constitute the energy storage device to be similar. The arrangement of the terminals (the positive electrode terminal and the negative electrode terminal) within one energy storage device is the same as the arrangement of the terminals (the positive electrode terminal and the negative electrode terminal) within another energy storage device used for comparison, and the terminals within one energy storage device and the terminals within the other energy storage device only need to have substantially the same size. In this case, if rotating one of a certain energy storage device and another energy storage device vertically or horizontally results in the same arrangement of terminals within the one energy storage device as the arrangement of terminals within the other energy storage device, then the two devices can be said to be of the same type.

The same applies to the third energy storage device group 93f. The second energy storage device group 92f has the same type as the first energy storage device group 91f, but is located in an inverted posture in the Z-axis direction. The same applies to the fourth energy storage device group 94f.

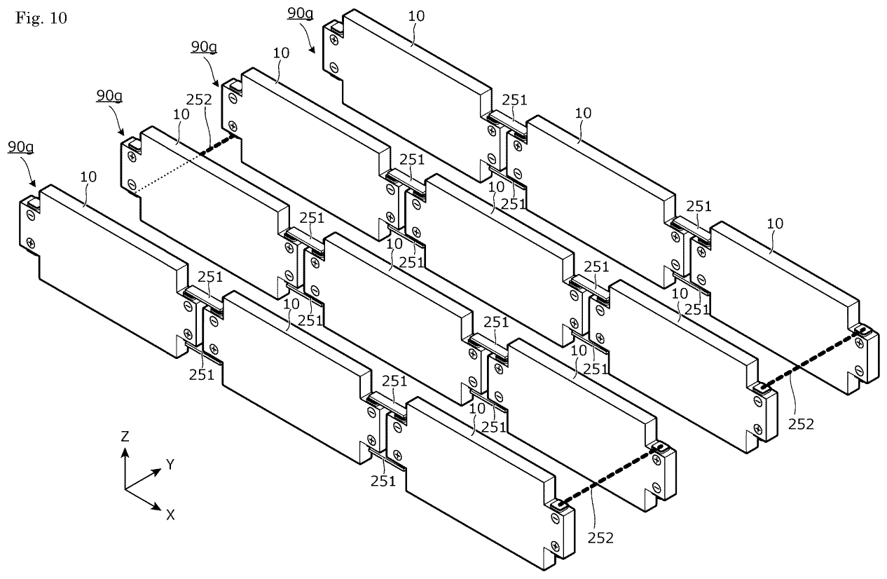

Modification Example 3 of the above example embodiments will be described. In the above example embodiments, an example was given in which the energy storage device group 90 is including only two energy storage devices 10. This Modification Example 3 describes the case where X is 3, that is, an energy storage device group 90g including three energy storage devices. FIG. 10 is a perspective view illustrating a plurality of energy storage device groups 90 g according to Modification Example 3 in an unfolded state. FIG. 10 is a diagram that corresponds to FIG. 7.

As illustrated in FIG. 10, each energy storage device group 90g has three energy storage devices 10 arranged in the X-axis direction. Two adjacent energy storage devices 10 in the X-axis direction are electrically connected in parallel by a parallel bus bar 251. Two adjacent energy storage device groups 90g in the Y-axis direction are electrically connected in series by a series bus bar 252.

Even when three or more energy storage devices 10 are located in the X-axis direction and electrically connected in parallel within each of the three or more energy storage device groups 90g that are electrically connected in series in this manner, it is still possible to make the energy storage apparatus compact. For example, while it is not impossible to connect three or more conventional two-terminal energy storage devices in parallel, it has been difficult to create a simple connection structure. In the energy storage device group 90g of the present modification example, since each energy storage device 10 includes four terminals (two positive electrode terminals and two negative electrode terminals), it is possible to create a simpler connection structure when connecting three or more energy storage devices in parallel. In other words, while it is not impossible to connect three or more two-terminal energy storage devices in parallel, in order to implement the connection, a bus bar structure connecting terminals is complicated and long, which causes an increase in resistance of the energy storage apparatus. According to the present modification example, it becomes possible to shorten the bus bars connecting the terminals, thereby reducing the resistance of the energy storage apparatus. Furthermore, it is possible to improve the power and charging performance of the energy storage apparatus. In addition, the cost of the energy storage apparatus can also be reduced.

In addition to the above, an energy storage device group may be formed by arranging, in the X-axis direction, three energy storage devices (such as the first energy storage device 11f in Modification Example 2) in which the positive electrode terminal and the negative electrode terminal are located to be inverted in the Z-axis direction on the first side surface portion and the second side surface portion.

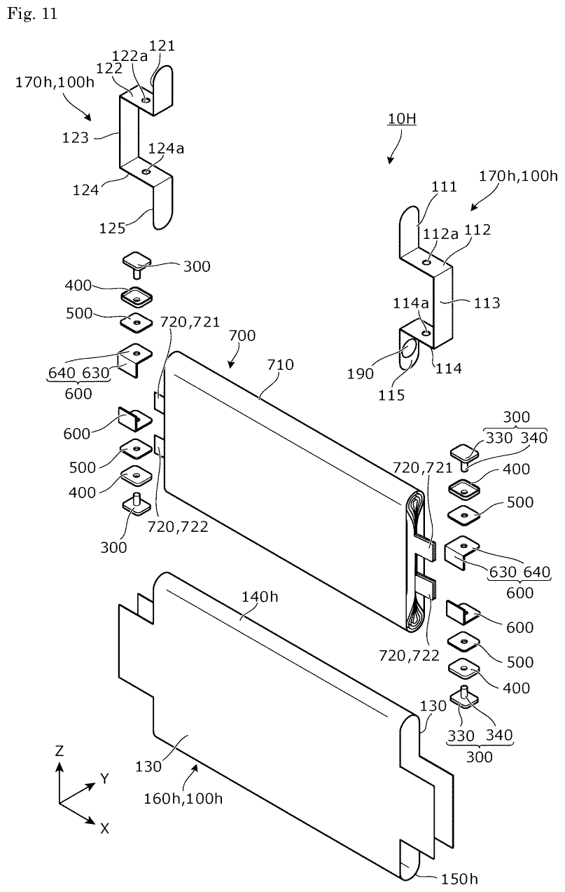

In the above example embodiments, an example was given in which the energy storage device 10 includes a case 100 with a flat top surface 140 and a flat bottom surface 150. This Modification Example 4 describes an energy storage device that includes a case with a curved top surface and a curved bottom surface. FIG. 11 is an exploded perspective view illustrating individual components of an energy storage device 10H according to Modification Example 4 when it is disassembled. FIG. 11 is a diagram that corresponds to FIG. 4.

As illustrated in FIG. 11, a case 100h is a case having an external shape based on an elongated cylindrical shape, which is elongated in the X-axis direction and flattened in the Y-axis direction. In this case 100h, the two opposing end surfaces in the Y-axis direction are each long side surfaces 130. Each long side surface 130 is a plane parallel to the XZ plane and elongated in the X-axis direction, with both end portions in the X-axis direction having a shape corresponding to the first side surface portion 110 and the second side surface portion 120. In the case 100h, among the two opposing end surfaces in the Z-axis direction, the end surface in the positive Z-axis direction is a top surface 140h, and the end surface in the negative Z-axis direction is a bottom surface 150h. The top surface, 140h, is a long, curved surface in the X-axis direction and protrudes in the positive Z-axis direction. The bottom surface 150h is a long, curved surface in the X-axis direction and protrudes in the negative Z-axis direction.

The case 100h has a case body 160h and a pair of lids 170h, and when the case body 160h and each lid 170h are assembled, the case 100h forms an elongated cylindrical shape. The case body 160h is formed in the shape of a long cylinder that penetrates in the X-axis direction.

The pair of lids 170h are members that seal both end portions of the case body 160 in the X-axis direction. One of the lids 170h seals the end portion of the case body 160h in the positive X-axis direction. One of the lids 170h is formed of a plate-like metal and is bent to correspond to the shape of the end portion of the case body 160h in the negative X-axis direction. One of the lids 170h has a first upper side surface 111, a first upper surface 112, a first middle side surface 113, a first lower surface 114, and a first lower side surface 115. The other lid 170h seals the end portion of the case body 160h in the negative X-axis direction. The other lid 170h is formed of a plate-like metal and is bent to correspond to the shape of the end portion of the case body 160 in the positive X-axis direction. The other lid 170h has a second upper side surface 121, a second upper surface 122, a second middle side surface 123, a second lower surface 124, and a second lower side surface 125.

With this configuration, the case 100h is structured such that after the electrode assembly 700 and the like are housed inside the case body 160h, the case body 160h and the lid 170h are joined by welding or the like to seal the inside.

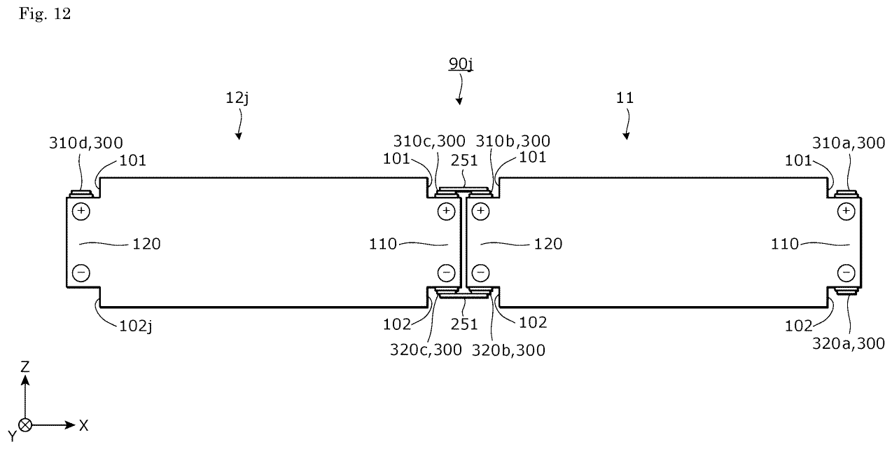

In the above example embodiments, an example was given in which all energy storage devices 10 of each energy storage device group 90 include four terminals 300. However, in some of the energy storage devices 10 according to the example embodiments, the electrical connection as an energy storage apparatus may be completed even if one or more of the four terminals 300 are not used. In this case, it is not necessary to provide, on the energy storage device 10, terminals that are not connected to the target object. This Modification Example 5 describes an energy storage device group having an energy storage device in which terminals that are not connected to the target object have been removed (that is, not provided). FIG. 12 is a plan view illustrating an energy storage device group 90 j according to Modification Example 5. FIG. 12 is a diagram that corresponds to FIG. 6.

In the energy storage device group 90j illustrated in FIG. 12, the first energy storage device 11 includes four terminals 300, but a second energy storage device 12j includes three terminals 300. Specifically, the second energy storage device 12j does not have a terminal in a second recess 102j in the negative X-axis direction. In this case, it is not necessary to pre-form a through hole for terminal installation in the second recess 102j, or the formed through hole may be sealed by laser welding or the like.

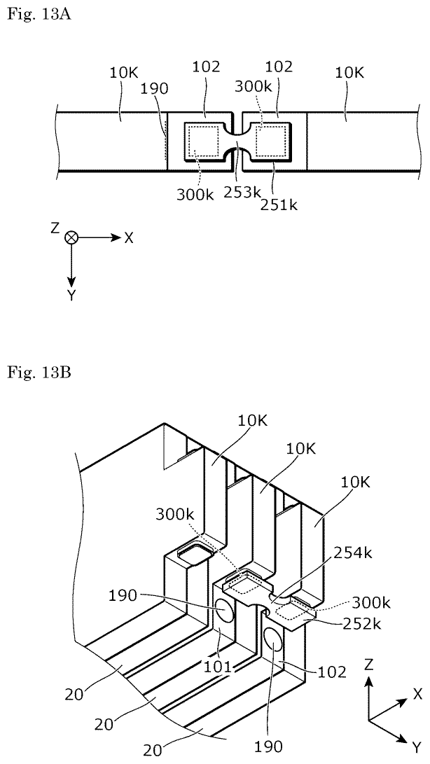

Modification Example 6 describes a modification example of the bus bar. FIG. 13A is a top view illustrating a bus bar 251k within an energy storage device group according to Modification Example 6. The bus bar 251 k within the energy storage device group includes a fuse portion 253k in which the cross-sectional area (cross-sectional area parallel to the YZ plane) of the intermediate portion in the direction connecting energy storage devices 10K (intermediate portion in the X-axis direction) is smaller than the cross-sectional area (cross-sectional area parallel to the YZ plane) of the other portions in the X-axis direction. Here, the intermediate portion can also be described as the intermediate portion of the bus bar 251k within the energy storage device group in the direction in which current flows. Furthermore, the cross-sectional area of the bus bar 251k within the energy storage device group is the area of the cross-section perpendicular to the direction in which the current flows. The fuse portion 253k is the portion of the bus bar 251k within the energy storage device group that has the smallest cross-sectional area at the position where it is sandwiched in the X-axis direction between two terminals 300k connected by the bus bar 251k within the energy storage device group. The fuse portion 253k is a portion designed to be physically cut when a large current flows through it. For example, when a malfunction causes a short circuit in one energy storage device 10K, a large current may flow to other energy storage devices via the bus bar 251k within the energy storage device group. In such cases, a large current flows through the fuse portion 253k of the bus bar 251k within the energy storage device group, causing the fuse portion 253k to be cut. It is possible to suppress a large current from flowing from the short-circuited energy storage device 10K to other energy storage devices.

Furthermore, in at least one of the two energy storage devices 10K connected by the bus bar 251k within the energy storage device group, a gas release valve 190k may be provided in the recess (the first recess 101 or the second recess 102) where the bus bar 251k within the energy storage device group is located. This makes it possible to cut the fuse portion 253k of the bus bar 251k within the energy storage device group with the high-temperature gas discharged from the gas release valve 190k.

FIG. 13B is a perspective view illustrating a bus bar 252k between energy storage device groups according to Modification Example 6. The bus bar 252 k between energy storage device groups includes a fuse portion 254k in which the cross-sectional area (cross-sectional area parallel to the XZ plane) of the intermediate portion in the direction connecting adjacent energy storage device groups (intermediate portion in the Y-axis direction) is smaller than the cross-sectional area (cross-sectional area parallel to the XZ plane) of the other portions in the Y-axis direction. Here, the intermediate portion can also be described as the intermediate portion of the bus bar 252k between energy storage device groups in the direction in which current flows. Furthermore, the cross-sectional area of the bus bar 252k between energy storage device groups is the area of the cross-section perpendicular to the direction in which the current flows. The fuse portion 254k is the portion of the bus bar 252k between energy storage device groups that has the smallest cross-sectional area at the position where it is sandwiched in the Y-axis direction between two terminals 300k connected by the bus bar 252k between energy storage device groups. In the bus bar 252k between energy storage device groups, a large current flows through the fuse portion 254k, causing the fuse portion 254k to be cut. It is possible to suppress a large current from flowing from the short-circuited energy storage device group to other energy storage device groups.

In at least one of the two energy storage devices 10K connected by the bus bar 252k between energy storage device groups, a gas release valve 190 may be provided in the recess (the first recess 101 or the second recess 102) where the bus bar 252k between energy storage device groups is located. This makes it possible to cut the fuse portion 254k of the bus bar 252k between energy storage device groups with the high-temperature gas discharged from the gas release valve 190.

The fuse portion may be provided in some of the bus bars. For example, among a plurality of bus bars within an energy storage device group included in one energy storage device group, a fuse portion may be provided in only one bus bar within an energy storage device group. Among a plurality of bus bars between energy storage device groups connecting a plurality of energy storage device groups, a fuse portion may be provided in only one bus bar between energy storage device groups.

Although the energy storage apparatuses according to the example embodiments of the present invention have been described above, the present invention is not limited to the above example embodiments. The example embodiments disclosed herein are examples in all respects, and the scope of the present invention includes all modifications within the meaning and scope equivalent to the claims.

For example, in the above example embodiments, the case in which only one electrode assembly 700 is housed in the case 100 was illustrated, but a plurality of electrode assemblies may be housed in the case.

In the above example embodiments, a wound electrode assembly 700 was illustrated. However, the configuration of the electrode assembly is not limited to a wound type; it may also be a stacked type with flat plates stacked on top of each other, or a shape in which the plates and/or separators are folded in a bellows shape. Specific examples of the latter include a configuration in which the separator is folded in a bellows shape to sandwich the rectangular electrode plate, and a configuration in which the plate and the separator are stacked and then folded in a bellows shape. A bipolar electrode assembly may be used.

In the above example embodiments, the energy storage apparatus 1 including the plurality of energy storage device groups 90 was illustrated. However, the energy storage apparatus only needs to have at least one energy storage device group, and the number of energy storage device groups installed may be any number.

In the above example embodiments, examples were given in which the terminal installation surface is the first upper surface 112, the first lower surface 114, the second upper surface 122, or the second lower surface 124. However, the first upper side surface, the first lower side surface, the second upper side surface, or the second lower side surface may be used as the terminal installation surface. In this case, each terminal on the first side surface portion will be a posture oriented in the positive X-axis direction, and each terminal on the second side surface portion will be a posture oriented in the negative X-axis direction.

In the above example embodiments, an example was given in which the energy storage device 10 includes four notch portions (the first recess 101 and the second recess 102). However, the number of notch portions installed may be any number, and the notch portions may not be provided.

The terminals provided in each energy storage device may be bolt terminals. The notch portions (the first recess and the second recess) may be cut out in a curved shape, at least in part.

Any combination of the components included in the above-described example embodiments and its modification examples is also included within the scope of the present invention.

Example embodiments of the present invention are applicable to energy storage apparatuses each including an energy storage device such as a lithium ion secondary battery.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage apparatus comprising:
an energy storage device group in which X energy storage devices arranged in a first direction are electrically connected in parallel; wherein
among the X energy storage devices, an Nth energy storage device, which is an energy storage device located at an Nth position, where N is a natural number and 1≤N≤X−1, from a first energy storage device, which is an energy storage device located at an end in the first direction, includes:
as an end portion in the first direction:
a (2N−1)th end portion where a (2N−1)th positive electrode terminal and a (2N−1)th negative electrode terminal are located; and
a (2N)th end portion where a (2N)th positive electrode terminal and a (2N)th negative electrode terminal are located;
an (N+1)th energy storage device adjacent to the Nth energy storage device includes:
as an end portion in the first direction:
a (2N+1)th end portion where a (2N+1)th positive electrode terminal and a (2N+1)th negative electrode terminal are located; and
a (2N+2)th end portion where a (2N+2)th positive electrode terminal and a (2N+2)th negative electrode terminal are located;
the (2N)th end portion and the (2N+1)th end portion face each other in the first direction;
the (2N)th positive electrode terminal and the (2N+1)th positive electrode terminal are electrically connected; and
the (2N)th negative electrode terminal and the (2N+1)th negative electrode terminal are electrically connected.

2. The energy storage apparatus according to claim 1, further comprising:
x energy storage device groups; wherein
the x energy storage device groups are located along a third direction orthogonal to both a second direction, which is a direction in which the (2N)th positive electrode terminal and the (2N)th negative electrode terminal are aligned, and the first direction; and
among the x energy storage device groups, an nth energy storage device group, which is an energy storage device group located at an nth position, where n is a natural number and 1≤n≤x−1, from a first energy storage device group, which is an energy storage device group located at an end in the third direction, and an (n+1)th energy storage device group adjacent to the nth energy storage device group are electrically connected in series.

3. The energy storage apparatus according to claim 2, wherein
an arrangement of a first positive electrode terminal and a first negative electrode terminal of a first energy storage device provided in the nth energy storage device group is an arrangement obtained by inverting, in the second direction, an arrangement of a first positive electrode terminal and a first negative electrode terminal of a first energy storage device provided in the (n+1)th energy storage device group; and
an arrangement of a (2X)th positive electrode terminal and a (2X)th negative electrode terminal of an Xth energy storage device provided in the nth energy storage device group is an arrangement obtained by inverting, in the second direction, an arrangement of a (2X)th positive electrode terminal and a (2X)th negative electrode terminal of an Xth energy storage device provided in the (n+1)th energy storage device group.

4. The energy storage apparatus according to claim 2, further comprising:
a positive electrode external terminal, a negative electrode external terminal, and a housing that houses the x energy storage device groups; wherein
the positive electrode external terminal and the negative electrode external terminal are electrically connected to the x energy storage device groups connected in series.

5. The energy storage apparatus according to claim 1, wherein
the (2N−1)th end portion includes:
a (2N−1)th positive electrode notch portion where the (2N−1)th positive electrode terminal is located; and
a (2N−1)th negative electrode notch portion where the (2N−1)th negative electrode terminal is located; and
the (2N)th end portion includes:
a (2N)th positive electrode notch portion where the (2N)th positive electrode terminal is located; and
a (2N)th negative electrode notch portion where the (2N)th negative electrode terminal is located.
